(19) United States
(12) Patent Application Publication
(10) Pub. No.: US 2014/0278659 A1
(43) Pub. Date: Sep. 18, 2014

(54) SYSTEMS AND METHODS FOR CREATING TEAM OF TEAMS

(71) Applicant: NAMELY, INC., New York, NY (US)

(72) Inventor: Matthew Straznitskas, Redding, CT (US)

(73) Assignee: NAMELY, INC., New York, NY (US)

(21) Appl. No.: 13/844,121

(22) Filed: Mar. 15, 2013

(51) Int. Cl. G06Q 10/06

(52) U.S. Cl. CPC G06Q 10/063118
USPC 705/7.17

(57) ABSTRACT

A system and method for creating team of teams is disclosed. In one example, the method comprises storing data descriptive of a plurality of teams including a first team comprising of a first plurality of employees and a second team comprising of a second plurality of employees, storing data descriptive of a first set of connections between the first plurality of employees and a second set of connections between the second plurality of employees; store data descriptive of a financial cost for the first team and a financial cost of the second team, receiving an instruction to combine the first team with the second team to produce a virtual team, and computing a financial cost associated with the virtual team comprising of the financial cost for the first team and the second team.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

Embodiments disclosed herein relate generally to systems for managing employee teams and, more particularly, to systems and processes of creating team of teams.

2. Discussion

In the current fast-paced job environment companies often experience volatile changes to their human capital. Early stage companies that experience rapid growth may look to quickly hire large numbers of employees and integrate them into already existing company structure. Later-stage companies commonly undergo mergers, acquisitions, lay-offs and other changes to the employee structure. In this environment, employees change their jobs rapidly and sometimes as often as every 3 to 5 years. Traditional employee management resources available to companies include human resource (HR) management systems that link financial and human resource functions in one database. These systems can provide payroll functions, time and absence functions, performance appraisal functions, HR management information functions, and recruiting and on-boarding functions.

### SUMMARY

Given this increase in volatility, companies are looking for ways to plan for attrition and expansion. Presently, however, companies lack the tools necessary to plan for volatility within the employee teams. In addition, given high turnover, companies are looking to optimize the value of employees currently in their employment.

Accordingly, the systems and methods described herein provide a team-focused approach to managing employees. Unlike traditional numbers-oriented HR management systems, the systems and methods described herein organize HR information already available to companies in a simple, visual, and easy-to-use way. The systems and methods use data from a combination of databases to track how employees are allocated across accounts and management teams.

According to one aspect, a computer system for creating team of teams, the computer system comprising a memory, a display, and at least one processor coupled to the memory and the display. In one embodiment, the at least one processor configured to store data descriptive of a plurality of teams including a first team comprising of a first plurality of employees and a second team comprising of a second plurality of employees, store data descriptive of a first set of connections between the first plurality of employees and a second set of connections between the second plurality of employees, store data descriptive of a financial cost for the first team and a financial cost of the second team, receive an instruction to combine the first team with the second team to produce a virtual team, and compute a financial cost associated with the virtual team comprising of the financial cost for the first team and the second team.

In one example, the at least one processor is further configured to store data descriptive of the virtual team, the virtual team comprising of a plurality of virtual employees based on the first plurality of employees and the second plurality of employees, and store data descriptive of a set of virtual connections between the plurality of virtual employees based on the first set of connections and the second set of connections. In another example, the at least one processor is further configured to display a representation of the virtual team including representations the plurality of virtual employees, and the set of virtual connections.

In at least one example, the at least one processor is further configured to receive a request to remove at least one virtual employee from the virtual team, remove, in response to receiving the request, the at least one virtual employee from the plurality of virtual employees, and remove, in response to receiving the request, at least one virtual connection of the set of virtual connections, the at least one virtual connection being associated with the at least one virtual employee.

In another example, the at least one processor is further configured to receive a request to add at least one new virtual employee to the virtual team, add, in response to receiving the request, the at least one new virtual employee to the plurality of virtual employees, and add, in response to receiving the request, a new virtual connection to the set of virtual connections, the new virtual connection being associated with the at least one new virtual employee.

In one example, the at least one processor is further configured to store data descriptive of the at least one new employee including data descriptive of a virtual salary and a virtual position. In another example, the at least one processor is further configured to receive a request to move at least one virtual employee within the virtual team, and adjust, in response to receiving the request, a connection of the set of virtual connections, the connection being associated with the at least one virtual employee.

In at least one example, the at least one processor is further configured to store data comprising an allocation for each virtual employee of the plurality of virtual employees. In another example, the at least one processor is further configured to store the allocation as a percentage of workload of each virtual employee associated with the virtual team in relation to other teams. In one example, the at least one processor is further configured to compute the financial cost based on salary information and the allocation.

According to another aspect a method of creating team of teams is disclosed. In one embodiment, the method comprises storing data descriptive of a plurality of teams including a first team comprising of a first plurality of employees and a second team comprising of a second plurality of employees, storing data descriptive of a first set of connections between the first plurality of employees and a second set of connections between the second plurality of employees, storing data descriptive of a financial cost for the first team and a financial cost of the second team, receiving an instruction to combine the first team with the second team to produce a virtual team, and computing a financial cost associated with the virtual team comprising of the financial cost for the first team and the second team.

In one example, the method further comprises storing data descriptive of the virtual team, the virtual team comprising of a plurality of virtual employees based on the first plurality of employees and the second plurality of employees, and storing data descriptive of a set of virtual connections between the plurality of virtual employees based on the first set of connections and the second set of connections.

In at least one example, the method further comprises displaying a representation of the virtual team including representations the plurality of virtual employees, and the set of virtual connections. In one example, the method further comprises receiving a request to remove at least one virtual employee from the virtual team, removing, in response to receiving the request, the at least one virtual employee from the plurality of virtual employees, and removing, in response to receiving the request, at least one connection of the set of virtual connections, the at least one connection being associated with the at least one virtual employee.

In another example, the method further comprises receiving a request to add at least one new virtual employee to the virtual team, adding, in response to receiving the request, the at least one new virtual employee to the plurality of virtual employees, and adding, in response to receiving the request, a new virtual connection to the set of virtual connections, the new virtual connection being associated with the at least one new virtual employee.

In one example, the method further comprises storing data descriptive of the at least one new virtual employee including data descriptive of a virtual salary and a virtual position. In yet another example, the method further comprises receiving a request to move at least one virtual employee within the virtual team, and adjusting, in response to receiving the request, a connection of the set of virtual connections, the connection being associated with the at least one virtual employee.

In at least one example, the method further comprises storing data comprising an allocation for each virtual employee of the plurality of virtual employees, wherein the allocation as a percentage of workload of each virtual employee associated with the virtual team in relation to other teams. In the example, the method further comprises computing the financial cost based on salary information and the allocation.

According to another aspect, a non-transitory computer readable medium storing instructions executable by at least one processor of a computer system is disclosed. In one embodiment, the instructions include instructions that instruct the computer system to store data descriptive of a plurality of teams including a first team comprising of a first plurality of employees and a second team comprising of a second plurality of employees, store data descriptive of a first set of connections between the first plurality of employees and a second set of connections between the second plurality of employees, store data descriptive of a financial cost for the first team and a financial cost of the second team, receive an instruction to combine the first team with the second team to produce a virtual team, and compute a financial cost associated with the virtual team comprising of the financial cost for the first team and the second team.

According to one embodiment, a mobile computing device is provided. The mobile computing device including a memory, a display, at least one processor coupled to the memory and the display and an interface executed by the at least one processor. The interface being configured to display representations of employees in a first level of an organizational structure and display representations of employees in a second level of the organizational structure below the representations of employees associated with the first level of organizational structure, wherein the representations of employees associated with the second level of the organizational structure are displayed proportionally smaller than the representations of employees in the first level of the organizational structure.

In the system, the second level of the organizational structure may be hierarchically lower than the first level of the organizational structure. The interface may be further configured to display the representations of employees associated with the second level of the organizational structure indented in relation to the representations of employees in the first level of the organizational structure. The interface may be further configured to receive a collapsing selection corresponding to at least one selected representation of the representations of employees. The interface may be further configured to remove, in response to the collapsing selection, at least one representation of the representations of employees displayed below the at least one selected representation. The interface may be further configured to receive an expanding selection corresponding to at least one selected representation of the representations of employees. The interface may be further configured to add, in response to the expanding selection, at least one representation of the representations of employees below the at least one selected representation. The interface may be further configured to receive a detail selection corresponding to at least one selected representation of the representations of employees. The interface may be further configured to display, in response to the detail selection, profile information associated with the least one selected representation of the representations of employees.

According to another embodiment, a method of displaying an organizational structure on a mobile computing device is provided. The method includes acts of displaying, on an interface of the mobile computing device, representations of employees in a first level of an organizational structure and displaying on the interface representations of employees in a second level of the organizational structure below the representations of employees associated with the first level of organizational structure, wherein the representations of employees associated with the second level of the organizational structure are displayed proportionally smaller than the representations of employees in the first level of the organizational structure.

In the method, the act of displaying, on the interface, representations of employees in the second level may include an act of displaying the second level of the organizational structure as hierarchically lower than the first level of the organizational structure. The method may further include an act of displaying the representations of employees associated with the second level of the organizational structure indented in relation to the representations of employees in the first level of the organizational structure. The method may further include an act of receiving, via the interface, a collapsing selection corresponding to at least one selected representation of the representations of employees. The method may further include an act of removing, in response to the collapsing selection, at least one representation of the representations of employees displayed below the at least one selected representation. The method may further include an act of receiving, via the interface, an expanding selection corresponding to at least one selected representation of the representations of employees. The method may further include an act of adding, in response to the expanding selection, at least one representation of the representations of employees below the at least one selected representation. The method may further include an act of receiving a detail selection corresponding to at least one selected representation of the representations of employees. The method may further include an act of displaying, in response to the detail selection, profile information associated with the least one selected representation of the representations of employees. The method may further include an act of displaying, on the interface, representations of employees includes displaying at least one of position information associated with an employee and a visual representation associated with the employee.

According to another embodiment, a non-transitory computer readable medium is provided. The computer readable medium stores computer executable instructions for displaying an organizational structure on a mobile computing device. The computer executable instructions include instructions that instruct at least one processor to display representations of employees in a first level of an organizational structure and display representations of employees in a second level of the organizational structure below the representations of employees associated with the first level of organizational structure, wherein the representations of employees associated with the second level of the organizational structure are displayed proportionally smaller than the representations of employees in the first level of the organizational structure.

According to one aspect, a computer system for managing employee teams is disclosed. In one embodiment, the computer system comprises a memory, a display, and at least one processor coupled to the memory and the display, the at least one processor configured to store data descriptive of a team including a plurality of employees and a set of connections between the plurality of employees, receive a request to clone the team, produce a cloned team including a plurality of virtual employees corresponding to the plurality of employees, the plurality of virtual employees having a set of virtual connections between the plurality of virtual employees, the set of virtual connections corresponding to the set of connections between the plurality of employees, and display a representation of the cloned team including a representation of the plurality of virtual employees and the set of virtual connections.

In one example, the at least one processor is further configured to compute a financial cost of the cloned team based on a financial cost of each virtual employee of the plurality of virtual employees. In at least one example, the at least one processor is further configured to receive a request to remove at least one employee from the cloned team, remove, in response to receiving the request, the at least one employee from the plurality of virtual employees, and remove, in response to receiving the request, at least one connection of the set of virtual connections, the at least one connection being associated with the at least one employee.

In another example, the at least one processor is further configured to receive a request to add at least one new employee to the cloned team, add, in response to receiving the request, the at least one new employee to the plurality of virtual employees, and add, in response to receiving the request, a new virtual connection to the set of virtual connections, the new virtual connection being associated with the at least one new employee. In at least one example, the at least one processor is further configured to receive data descriptive of the at least one new employee including data descriptive of a virtual salary and a virtual position.

In yet another example, the at least one processor is further configured to receive a request to move at least one employee within the cloned team, and adjust, in response to receiving the request, a connection of the set of virtual connections, the connection being associated with the at least one employee. In one example, the at least one processor is further configured to store data comprising an allocation for each virtual employee of the plurality of virtual employees. In this example, the allocation comprises a percentage of workload of each virtual employee associated with the cloned team in relation to other teams. In one example, the at least one processor is further configured to calculate a financial cost of each virtual employee based on the allocation. In at least one example, the at least one processor is configured to calculate profit and loss for the cloned team.

According to another aspect, a method for managing employee teams is disclosed. In one embodiment, the method comprises storing data descriptive of a team including a plurality of employees and a set of connections between the plurality of employees, receiving a request to clone the team, producing a cloned team including a plurality of virtual employees corresponding to the plurality of employees, the plurality of virtual employees having a set of virtual connections between the plurality of virtual employees, the set of virtual connections corresponding to the set of connections between the plurality of employees, and displaying a representation of the cloned team including a representation of the plurality of virtual employees and the set of virtual connections.

In one example, the method further comprises computing a financial cost of the cloned team based on a financial cost of each virtual employee of the plurality of virtual employees.

In another example, the method further comprises receiving a request to remove at least one employee from the cloned team, removing, in response to receiving the request, the at least one employee from the plurality of virtual employees, and removing, in response to receiving the request, at least one connection of the set of virtual connections, the at least one connection being associated with the at least one employee.

In another example, the method further comprises receiving a request to add at least one new employee to the cloned team, adding, in response to receiving the request, the at least one new employee to the plurality of virtual employees, and adding, in response to receiving the request, a new virtual connection to the set of virtual connections, the new virtual connection being associated with the at least one new employee.

In yet another example, the method further comprises storing data descriptive of the at least one new employee including data descriptive of a virtual salary and a virtual position. In one example, the method also comprises receiving a request to move at least one employee within the cloned team, and adjusting, in response to receiving the request, a connection of the set of virtual connections, the connection being associated with the at least one employee.

In a further example, the method comprises storing data comprising an allocation for each virtual employee of the plurality of virtual employees. In this example, the allocation comprises a percentage of workload of each virtual employee associated with the cloned team in relation to other teams. In addition, the method may further comprise calculating a financial cost of each virtual employee based on the allocation.

According to another aspect, a non-transitory computer readable medium storing instructions executable by at least one processor of a computer system is disclosed. In one embodiment, the instructions instruct the computer system to store data descriptive of a team including a plurality of employees and a set of connections between the plurality of employees, receive a request to clone the team, produce a cloned team including a plurality of virtual employees corresponding to the plurality of employees, the plurality of virtual employees having a set of virtual connections between the plurality of virtual employees, the set of virtual connections corresponding to the set of connections between the plurality of employees, and display a representation of the cloned team including a representation of the plurality of virtual employees and the set of virtual connections.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic diagram of a distributed computing system including an employee management system according to one example;

FIG. 2A is an illustration of a team screen provided by the employee management system according to one example;

FIG. 2B is an illustration of a new team screen provided by the employee management system according to one example;

FIG. 2C is an illustration of a company reporting screen provided by the employee management system according to one example;

FIGS. 3A-3B are illustrations of employee team screens provided by the employee management system according to one example;

FIG. 3C is an illustration of a detailed employee screen provided by the employee management system according to one example;

FIG. 4A is an illustration of a cloned team screen provided by the employee management system according to one example;

FIG. 4B is an illustration of a team listing screen provided by the employee management system according to one example;

FIG. 4C is an illustration of a merged team screen provided by the employee management system according to one example;

FIG. 5 is an illustration of the employee management system executing an application on a mobile device according to one example;

FIG. 6 is an illustration of the employee management system executing an application displaying an organizational structure on the mobile device according to one example;

FIG. 7 is a schematic diagram of one example of a computer system that may perform processes and functions disclosed herein;

FIG. 8 is a flow diagram of a method of managing employees in a team, according to one example; and

FIG. 9 is a flow diagram of another method of managing employees in a team, according to one example.

### DETAILED DESCRIPTION

Some of the aspects and embodiments disclosed herein describe systems and methods of managing employees within teams in a company structure. According to some embodiments, a computer system executes components that enable an employee management system to create a visual representation of the employees in the form of a team within a corporate structure, for example in the form of an organizational chart. Each of the employees in the team may include an allocation percentage associated with percent of capacity of that employee related to one or more particular teams. The embodiments described herein allow companies to get a quick snapshot of their employees, the teams associated with those employees, the products they produce, and the cost and revenue associated with those teams.

According to some embodiments, the employee management system can provide for a user to clone a team and display the cloned team to the user. The cloned team may include number of virtual employees that can be moved, added, and removed. The employee management system may calculate and display statistics to the user for the cloned team including financial information, such as cost, associated with the cloned team. In some examples, the employee allocation may be associated with financial information for the particular team. The cloned teams having virtual employees allow companies to visualize and plan for how changing existing teams affect team dynamics and the overall company.

According to other embodiments, a computer system executes components that enable the employee management system to create team of teams. The team of teams may be virtual teams created by combining or merging different cloned teams. Different scenarios and mixes of people on teams may allow the companies to plan for strategic placement of team members, combine different teams due to mergers or acquisitions, and plan for placement or movement of different management, and while accounting for salary and other overhead requirements.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples or embodiments are not intended to be excluded from a similar role in any other examples or embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Employee Management System

Some embodiments disclosed herein implement an employee management system using one or more computer systems, such as the computer systems described below with reference to FIG. 7. FIG. 1 illustrates an exemplary employee management system 102 within the context of an exemplary overarching distributed computer system 100. As shown in FIG. 1, the distributed computer system 100 includes users 104, a user interface 106, computer systems 108, a network 110 and external HR applications 112 and 114. The user may interact (e.g., provide or receive information) with the user interface 106 on one of the computer systems 108. According to these embodiments, the employee management system 102 receives and transmits information relating to employees or the company from the external HR applications 112 and 114.

According to various examples, the employee management system 102 includes an employee management server 116, and a database 118. The employee management system 102 is configured to receive employee and company information from the external HR application 112 and 114, and various inputs from the users via the user interface 106 and the computer systems 108 and provide a visual representation of one or more teams including a set of connections between the employees within the team. The visual representation can be provided to users of the employee management system 102 via the user interface 106. The employee management system 102 may allow for the user to manage, clone, or edit the team via the visual representation and can provide various reports to the user representing the impact or results of any changes to the team.

As depicted in FIG. 1, the computer systems 108, the external HR applications 112 and 114 exchange (i.e. transmit or receive) information via the network 110. The network 110 may include any communication network through which computer systems exchange information. For example, the network 110 may be a public network, such as the Internet, and may include other public or private networks such as LANs, WANs, extranets, intranets, and cloud computing systems. Although shown as a single network in FIG. 1, in some embodiments, the network 110 includes a plurality of communication networks.

In the embodiment illustrated in FIG. 1, the distributed system 100 is configured to implement the user interface 106 in conjunction with the computer systems 108 via the network 110. For example, in some embodiments illustrated by FIG. 1, the interface 106 is browser-based user interface served by employee management system 102. In still other embodiments, the interface 106 is a specialized client program that executes outside of a browser environment, such as an application program executing on a mobile device. The user interface 106 may be implemented using a variety of technologies and may include various elements (e.g., screens, windows, buttons, boxes, etc) arranged according to various user interface metaphors.

In one implementation, the external HR applications 112 and 114 may provide browser-based interfaces served by an external HR application server. In other embodiments, to the external HR applications 112 and 114 may allow the employee management system 102 to receive employee and company data stored in a database associated with the external HR applications 112 and 114. In at least one embodiment, a user with access to the external HR applications 112 and 114 may export employee and company data from the database in a plain text form so that it may be imported into the employee management system 102. In one example, the export files may include comma-separated values (CSV) files. However, it is appreciated that the information may be exported in any format that may be accessible by the employee management system 102.

Different external HR applications may be associated with different users and the companies with which the users are associated. For example, the external HR application 112 may be associated with one company and may be accessed by a user having permission to access the external HR application 112. In turn, the external HR application 114 may be associated with another company and may be accessed by another user having the necessary permissions. In some examples, the employee management system 102 may be granted permission to access employee and company information associated with multiple external HR applications. The external HR applications 112 and 114 may be independent of each other.

In some embodiments, the information exported from the external HR applications 112 and 114 may include employee and company information associated with employees of the company. The employee and company information may be received by the employee management system 102 and stored in the database 118. The information may include payroll information such as salary, raises, bonuses, benefits as well as other payroll information. In addition, the information may include time and absence information including total amount of hours, days, and years worked, vacation and sick days accrued and taken. The information may also include performance appraisal information including performance reviews, performance evaluations, probation periods, promotions and the like. Other information received from the external HR applications 112 and 114 may include recruiting and work force management information, for example, number of requisitions open, future positions planned, number of employees within first years of employment, current attrition rates, predicted attrition rates, planned lay-offs as well as other recruiting or work force management information.

In one implementation, the employee and company information received from the external HR applications may be stored in the database 118 and may be periodically updated by the employee management system 102. For example, the employee management system 102 may synchronize the employee and company information stored in the database 118 with the employee information from the external HR applications 112 and 114 with using one or more protocols. In one example, the protocols can include procedures for receiving or downloading the employee information for every user in the external HR application once access is provided to the employee management system 102. In one example, the protocols can include procedures for periodically updating the employee information.

The employee management server 116 can provide access to the user interface 106 and receive and transmit information to the user via the user interface 106. The user interface 106 provides one or more screens to the user, the screens may enable the user to input employee information and manage the employee teams provided by the employee management system 102.

The user 104 may be a member of the company's HR personnel desiring to review and manage the employees on a particular team. In other examples, the user may be an external consultant determining what multiple teams would look like if the teams were merged together. In yet other examples, the user may be executives or directors looking to optimize productivity within a particular team or across other teams. The user can access the employee management server 116 via the user interface 106 and the employee management severs 116 can provide one or more employee team screens that allow the user to create new teams, view and manage previously created teams, merge or move team members across different teams, and view the financial impact of such decisions. Examples of such as the screens are displayed in FIGS. 2A-4C.

Information may flow between the components illustrated in FIG. 1, or any of the elements, components and subsystems disclosed herein, using a variety of techniques. Such techniques include, for example, passing the information over a network using standard protocols, such as TCP/IP, HTTP, or HTTPS, passing the information between modules in memory and passing the information by writing to a file, database, database, or some other nonvolatile data storage device, among others. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

In some examples, the management system 102 may be a cloud-based computing system. However, the employee management system 102 may be configured according to a variety of architectures. The architecture illustrated in FIG. 1 is provided for exemplary purposes only and embodiments disclosed herein are not limited to the architecture shown in FIG. 1. For example, in some of the embodiments, the physical components described below may be virtualized.

FIG. 2A illustrates one example of a team screen provided by the employee management system 102 which may provide for the user to view and manage employee teams. The team screen is one of the multiple screens available to the user with the navigation bar 206 to view and manage teams. As shown, the employee team areas 202a-1 are shown on the right in an ordered table form. Team sorting or ordering options 204 may be provided on the left and may provide for the user to sort and filter different teams. For example, based on user input, the employee management system 102 may display “all teams,” “active teams,” including those teams with recent activities or updates, “draft teams,” including those teams that are not completed, or “inactive teams,” including those teams without recent activities or updates. Other filtering options may be provided to the user, including filtering by different division types, for example “marketing” or filtering by different categories of teams, including any categories or division types associated with the teams. For those users with access to multiple teams, providing options to sort and filter different teams allows for the user to limit the number of teams shown and quickly get access to necessary team.

In some examples, the employee teams 202a-1 populate cells in the table and each cell further includes information about the particular team. For example, team name, the number of employees on the team, the number of open positions, information about when the team was last updated and any other information pertaining to the team. In some examples, the teams displayed to the user may include teams of employees 202a-1 associated with different client accounts. However, any teams of employees may be created and displayed. The employee management system 102 may receive a selection from the user to access one of the employee teams 202a-1. In addition, the employee management system 102 may provide for the user to access different screens, such as the “people” or the “company” screen part of the navigation bar 206.

In at least one example, the employee management system 102 may provide for the user to input information to add a new team, such as for example by providing a “add new team” option 208 on the team screen shown in FIG. 2A. In response to receiving a selection for the user to add a new team, the employee management system 102 may provide for the user a new team screen. FIG. 2B illustrates one example of a new team screen provided to the user. The new team screen may provide for the user to add a team name, and to build a team by adding on or more employees to the new team and place the new employees in positions in the team hierarchy. For example, a user can add a new employee to the team by selecting the option 212, in response to which a new employee profile cell 214 may appear unconnected in the team hierarchy. The employee management system 102 may provide for the user to drag and drop the new employee cell 214 in the hierarchy, for example under the other employees at a higher level in the hierarchy.

Once placed in the team, the user may add new employee 214 profile information such as name, title, allocation, as well as other employee profile information. In one example, the employee management system 102 can provide for the user to select an employee out of employees stored in the database 118. The employee profile information may be automatically filled from the information stored in the employee profile in the database 118.

The employee management system 102 can calculate and display team vitals regarding the new team, in one example, as the information in being input by the user. In one example, the vitals are calculated statistics for one or more teams and can include, for example, full-time equivalent (FTE) total for the team, performance percentage amount, experience total (in days), total salary for the team and the associated cost for the team.

In one example, the team vitals can be calculated by the employee management system 102 based on the information exported from the external HR applications 112 and 114 as well as any information input into the employee management system 102 via the user interface 106. In some examples, FTE indicates the number of persons utilized within the team. For example, in FIG. 2B, the director includes an allocation of 50 and is the only member of the team, resulting in an FTE of 0.5. The allocation can be entered by the user and is based on the employee's projected contribution to the team.

Performance may be calculated based on each team member's most recent performance review, equally weighted across the team members of a particular team. In the example of FIG. 2B, no performance reviews have occurred, therefore the performance is shown as 100%. The performance review information, in one example, may be received from the information the external HR applications 112 and 114. The cost of the team, in one example, may be calculated by each person's salary divided by their allocation. In the example shown in FIG. 2B, the only employee currently in the team has a salary of $150,050 and allocation of 50%, to resulting in a team cost of $75,025.

As shown in FIG. 2B, these team vitals can be displayed in a pull down menu hovering over the visual representation of the team. The team vitals can be calculated by the employee management system 102 based on the information exported from the external HR applications 112 and 114 as well as any information input into the employee management system 102 via the user interface 106.

According to an embodiment, the teams, including the employees within the teams, the links between the employees and the details associated with the employees can be input by a user in the employee management system 102 and stored in the database 118. In at least one example, the employee management system 102 may automatically determine the corporate structure, the teams and the links between the employees of the team based on information provided from the external HR applications 112 and 114. This information may be correlated to other information received from the external HR applications 112 and 114, discussed above.

In one example, employee titles can be used to create different teams and determine the level of the hierarchy associated with the employee. For example, an employee with a titled of “VP Sensors and Controls (Americas)” may be determined to be at the highest level of the hierarchical team of “sensors and controls (Americas).” Other employees in the “sensors and controls” teams can include Director, Senior Manager, Manager, Marketing Manager, Engineering manager, R&D Manager, as well as other employees having other titles. The employee management system 102 can use this information, along with predetermined rules to determine the hierarchical structure. For example, the rules may place VP employees above Director employees, and Senior Manager employee above other managers in the hierarchy.

In various examples, the employee management system 102 calculates and displays team vitals regarding one or more teams stored in the database 118. In one example, the vitals are calculated statistics for one or more teams and can include, for example, full-time equivalent (FTE) total for the team, performance amount, experience total, total profit and loss associated with the team, and total salary for the team and total cost for the team.

In one example, the allocation percentage, described above, can be associated with a financial cost of employees within the team. The team vitals may display financial cost based on the allocation percentage as the combined salary of the team divided by the allocation amount. In at least one example, the vital may provide profit associated with a team. For example, for a professional services team, each employee may be billed out at a certain amount. The allocation can be tied to the amount billed for each employee and calculated as a total for the team. In an example, the team vitals may include FTE, which may be a percentage of time associated with an employee in a way that makes workloads comparable across multiple teams.

The presentation of team vitals allows a user to optimize one or more groups or to build virtual teams. In various examples, by displaying the team vitals above the visual representation of the team allows the user to see immediate impact on the team and the company. For example, the user may change the allocation for one employee, and in response to the change may see an immediate change to the financial cost and other team vitals.

In another implementation, the team vitals for each individual team can be used to calculate and display overall company vitals. FIG. 2C illustrates one example of displaying company vitals via a company vital screen. The company vitals displayed in the company vitals screen, in one example, can be calculated by the employee management system 102 by combining the team vital for the individual teams and including information exported from the external HR application systems 112 and 114.

The company vitals can include statistical information that can be calculated and displayed to a user via the user interface 106. The company vital include team information 214, utilization rates 216, historical information for hires and departures 218 including total number of employees and growth associated with the company 220. The company vitals can include information for all the teams 214 associated with the company, which can be displayed as a single bar graph showing the active, inactive and draft teams in different colors and occupying a portion of the total team count.

In some examples, new, cloned, or team of teams may be created with a status of “draft” and may remain as such until the user finalizes the team structure and information. Once the team is finalized, the team changes the status from “draft” to “active.” According to one example, the information associated with an active team is included in the company vitals, while the information associated with a draft team is excluded. One or more teams may also be changed from “active” status to “inactive” status, which would also exclude them from the company vitals.

According to one example, the company vital screen may display to the user the history hires and departures rates 218 associated with the employees of the company including the total number of employees and the employee percentage growth for a particular period of time 220. This information may provide an understanding of the overall health of the company, whether the company is expanding or contracting.

In one example, the company vitals screen can provide the company utilization rate 216, which may be based on every person's allocation across all teams divided by the total number of employees. In addition, the employee management system 102 can determine performance levels 228 and allocation of people 214 for the overall company and display. It is appreciated that other team and company vitals may be calculated and displayed to the user.

FIGS. 3A and 3B illustrate examples of specific team screens 300A and 300B provided by the employee management system 102 to the user 104 via the user interface 106. The teams shown may be displayed in response to receiving a selection input from the user to view one of the team cells shown in FIG. 2A. In these examples, the teams are displayed in a hierarchical order and include one or more of the employees associated with the selected team. FIG. 3A illustrates one example of a hierarchical team structure 300A including a number of employees in the team. FIG. 3B shows another example of a hierarchical team 300B having a more complex structure including multiple levels of lateral employees.

Each of the employees in the team is connected to one or more members of the team via connections or links 302. In this implementation, the organization of the team corresponds to the structural relationship of the employees within the company. Such relationships may include managers to sub-workers, directors to managing or associate directors, chief executive officers to various departments, senior contributors to junior contributors as well as other structural relationships. The links 302 may represent direct reporting connections within the organizational structure.

Hence, in the examples of FIGS. 3A and 3B, the hierarchical arrangement of the employees on the team is associated with hierarchical order of employees within the company. For example, in FIG. 3A the team includes highest ranking employee 306A displayed at the top of the hierarchy as the director of the group and employees 308A, 310A and 312A displayed below at different levels of the hierarchy include associate directors, and individual contributors (both senior and junior). The employee 312A reports to employee 310A who is directly above the employee 312A in the hierarchy. Similarly, employees 310A report to respective employee 308A in the hierarchy. The team in FIG. 3A also shows lateral relationships including employees 308A who work on the same level and both report to employee 306A.

In some examples, the employee management system 102 may provide for the user to expand or collapse the members of the team below a level of a hierarchy. These expansion options can isolate for the user one part of the team versus another. Whether additional members of the team are available to be displayed may be indicated with a visual representation, such as for example, a plus sign located on a corner of an employee cell.

It is appreciated that other organizational structures can be displayed including a matrix structure, a flat or horizontal structure as well as non-linear organizational structures. For example, the organizational structure may be presented as an organigraph which may be displayed as a graphical representation of a company's non-linear structure or processes. The organigraph may be used to present non-direct reporting relationships, for example, relationships between different departments in a company, relationships between different product lines, supply chains, and other relationships within an organization.

Referring again to FIGS. 3A and 3B, the employee information associated with each employee in the team is displayed in the cell associated with the employee. The information may include employee name, position, location, an image associated with the employee, and an allocation percentage associated with the employee. It is appreciated that other information may be available to the user and the employee management system 102 may provide for the user options to hide or show any information available. The employee management system 102 may provide for the user to view a profile associated with each of the employees on the team.

The employee management system 102 may allow the user to create an “open position” in the team, such as the open position 308A in FIG. 3A. The open position may be associated with a position for an employee who has left the company. In other examples, the open position may be associated with company reorganization of the team. The open position may have salary and other cost requirements that may be determined based on a number of factors. For example, the salary and cost requirements may be based on market information, historical data pertaining to employees, and other employee roles for example lateral employees in the organization.

FIG. 3C illustrates one example of a screen showing profile details associated with one of the employees in the team. In one embodiment, the employees within the team may be allocated to one or more teams within a company or organization. For example, an employee in a professional-service industry may be divided between multiple teams; in consulting, legal, sales or advertising agencies, professionals may be working with multiple client or customer teams. In other examples, administrative professionals or software developers may be supporting multiple groups within a company. Tracking allocation of these professionals between teams may allow for companies to understand and optimize the productivity of its employees. As shown in FIG. 3C, the profile of an employee 304C displays that the employee is allocated across three separate teams, including the “Taco Bell” team, the “Coca Cola” team, and the “Walmart Account” team. As described above, the allocation for each employee may be entered based on the employee's perceived contribution to the team. In some examples, for example in some professional services industries, the employees may be billed out to the clients at more than 100%. the allocation of an employee.

In the embodiments, the employee management system 102 provides for users to create virtual teams in order to plan for future growth or attrition, or to organize teams to determine an optimal team. One example of creating virtual teams includes a creating a “cloned team.” In one or more team screens, such as the screens shown in FIGS. 2B and 3A, the employee management system 102 can provide for the user to select a “clone team” option while viewing a particular team (e.g. option 314 in FIG. 3A and option 230 in FIG. 2B). In response, the employee management system 102 can create a copy of the particular team as a cloned team, which may be added to the team listing as a “clone of [team name]”, as shown in FIG. 2A. The cloned team can be displayed to the user to edit, manage and finalize, as shown in FIG. 4A.

In one implementation, the cloned team 400 may be a virtual team including a simulated team including virtual employees and virtual connections between the virtual employees. The virtual employees, in one example, are based on the employees of the original team. In displaying the cloned team, the employee management system 102 may provide for the user to add virtual employees to the team in particular position in the company's organizational structure. For example, the employee management system 102 may provide for the user to select “add person to team” option, such as the option 402. Connections or links to other employees in the team can also be created for the new virtual employee.

Further, in displaying the cloned team, the employee management system 102 may provide for the user to remove virtual employees from the cloned team. Connections associated with the removed virtual employee may also be removed. In addition, the employee management system 102 may provide for the user to move one or more virtual employees on the cloned team to other positions within the team. For example, the virtual employee may be moved because of a promotion, demotion, or a lateral change. Connections associated with the moved virtual employee may also be removed and added accordingly.

In some examples, financial information may be displayed to the user for the associated cloned team. The financial information may be copied from the original team, but may change based on the changes to the team. In some examples, the employee management system 102 may total cost associated with the cloned team such as the total cost. As described above, the total cost may be the combined salary information for the team, divided by the allocation amount for each member of the team. The total salary and cost information for the cloned team may not be included in the company vitals as described in reference to FIG. 2C. In this way, the virtual team can be used for planning purposed without duplicating costs for the company. The cloned team status may be changed from “draft” to “active” as a result of which the financial information associated with the cloned team can be added to the company vitals information.

The employee management system 102 may provide for the user to change the allocation associated with one or more employees in the virtual teams and calculate the resulting financial impact of the allocation on the team. As noted in an example above, the allocation of an employee may be tied to the total cost. By changing the allocation associated with one or more virtual employees, the user can optimize the teams within a company and increase the total profit.

In another embodiment, the employee management system 102 provides for users to create “team of teams” that include merging multiple teams together to create a merged team. The team of teams can allow for users to plan for mergers and acquisitions or for reorganization plans within the company. For example, the employee management system 102 can use the team of teams functionality to merge a west coast sales team with an east coast sales team to analyze a single virtual sales team under a single management structure.

In the team listing screen, such as the screens shown in FIG. 2A, the employee management system 102 can provide for the user to select a “team of teams” option, such as the option 240 shown in FIG. 2A. In response to the team of teams selection, the employee management system 102 can provide for the user to select one or more teams within the team listing, as shown in FIG. 4C. In response, the employee management system 102 can create a copy of the one or more selected teams, as a team of teams, which may be added to the team listing as a new “team of teams,” such as for example the executive management team of teams 260. A representation of the team of teams can be displayed to the user to edit, manage and finalize, as shown in FIG. 4C.

In another implementation, the employee management system 102 can provide for the user to select a team of teams option in one or more team screens, such as the screens shown in FIGS. 2B and 3A, the employee management system 102 can provide for the user to select a “team of teams” option while viewing a particular team (e.g. option 330 in FIG. 3A and option 250 in FIG. 2B).

In one implementation, the team of teams may be displayed the on the same screen, for example, side-by-side as shown in FIG. 4C, including team 404 and team 406. The combined display of the multiple cloned teams can allow the user to merge the multiple teams as desired. The resulting merged team may be a virtual team including virtual employees. In one implementation, the merged team may be finalized and added as a new “active” team to the listing of teams. The employee management system 102 may

One or more employees on the merged team may be moved, removed, or added. For example, the employee management system 102 may provide for the employee 412 of team 406 to be moved to the open position 414 on team 404. In one example, the employee management system 102 may provide for the user to create new connections between team members of different teams, such as the employee 408 of team 408 and employee 410 of team 406. The team vitals for the merged team may be displayed to the user as changes are made to the employees of the merged team. The resultant vitals may allow for the user to assess the merged team and make further changes based on the displayed vitals.

According to one implementation, the employee management system 102 may be executed as an application program on a mobile device, such as for example the mobile device shown in FIG. 5. The navigation bar 206 shown in FIG. 2A may be displayed in a table including cells representing each of the functions, teams, people, company and favorites as shown in FIG. 5.

It is appreciated that some mobile devices provide a proportionally smaller display than the displays that may be available with other mobile devices. In order to provide the team representations as shown in FIGS. 3A and 3B, the employee management system 102 may be configured to display another illustration of the organizational team structure in a format that allows the employees of the team to fit within the proportionally smaller display. In one implementation, the employee management system 102 displays cells of employees in the levels of hierarchy as described above.

FIG. 6 illustrates one example of the organizational structure, such as a hierarchical structure, displayed on a mobile device 600 including a mobile device display 620. The cells for employees 602-610 can include depictions 602a-610a associated with the employees including photos, drawings, caricatures, geometric shapes, symbols, or other visual depictions. The cells for the employees 602-610 can also include a description of each employee, including for example, the employee name and the employee position in the company. It is appreciated that other information may be displayed in each of the employee cells 602-610, such as for example, participation in each team associated with the company, the allocation associated with team, start date information, performance information or other information associated with the employee.

In one example, the cells 602-610 in the organizational hierarchy can comprise rectangular shapes and can be displayed as extending across the width of the mobile device display 620. Each of the cells may have equal height in relation to the other cells. In one example, the employees at the highest level of the organizational hierarchy (e.g. most senior) are displayed having the depictions of proportionally larger size than the size of the depictions on the lower levels of the organization (e.g. junior). As shown in FIG. 6, the cell associated with the highest level of the organizational hierarchy 602 includes the associate director. In this example, the depiction 602a of the associate director is shown proportionally larger than the depiction of the employees in the lower levels of the organization 604-608. In this example, each of the depictions 604a-608a of the cells 604-608 is smaller than the depictions in the cell above.

In another example, the cells of employees at the lower levels of the organization can be displayed having the cells including information that is tabbed or indented in relation to the cells on the higher levels of the organization. For example, the cells associated with the level of Supervisor 604 including information that is indented in relation to the cells associated with the level of the Associate Director 602, the cell 604 being lower in the organizational hierarchy. Similarly, the cell 606, which is associated with a level of the organization lower than the level associated with the cell 604, includes information that is indented in relation to the cell 604. In some examples, cells associated with lateral employees in the organization hierarchy can display information having the same indent as other cells associated with employees having the same level of hierarchy. For example, the cells associated with the Associate Directors 610 and 602 can display information having the same indent.

In one example, the user can see more or less of the organizational structure by expanding and collapsing the cells associated with the employees of the organization. In one implementation, in response to receiving an expansion selection corresponding to one of the to employees in the higher level of the hierarchy, the employee management system 102 displays the cells associated with employees on the lower levels of the organization below the level selected. For example, the employee management system 102 displays the cell 604 in response to receiving an expansion selection corresponding to the cell 602. Similarly, the employee management system 102 displays the cell 606 in response to receiving an expansion selection corresponding to the cell 604.

In another example, in response to receiving a collapsing selection corresponding to one of the employees in the higher level of the hierarchy, the employee management system 102 removes from view the cells associated with the employees at lower levels of the hierarchy. For example, the employee management system 102 removes from view the cell 608 in response to receiving a collapsing selection corresponding to the cell 606. Similarly, the employee management system 102 removes the cell 606 in response to receiving a collapsing selection corresponding to the cell 604.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 7, there is illustrated a block diagram of a distributed computer system 700, in which various aspects and functions are practiced. As shown, the distributed computer system 700 includes one more computer systems that exchange information. More specifically, the distributed computer system 700 includes computer systems 702, 704 and 706. As shown, the computer systems 702, 704 and 706 are interconnected by, and may exchange data through, a communication network 708. The network 708 may include any communication network through which computer systems may exchange data. To exchange data using the network 708, the computer systems 702, 704 and 706 and the network 708 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 702, 704 and 706 may transmit data via the network 708 using a variety of security measures including, for example, TLS, SSL or VPN. While the distributed computer system 700 illustrates three networked computer systems, the distributed computer system 700 is not so limited and may include any number of computer systems and computing devices, networked using any medium and communication protocol.

As illustrated in FIG. 7, the computer system 702 includes a processor 710, a memory 712, an interconnection element 714, an interface 716 and data storage element 718. To implement at least some of the aspects, functions and processes disclosed herein, the processor 710 performs a series of instructions that result in manipulated data. The processor 710 may be any type of processor, multiprocessor or controller. Some exemplary processors include commercially available processors such as an Intel Xeon, Itanium, Core, Celeron, or Pentium processor, an AMD Opteron processor, an Apple A4 or A5 processor, a Sun UltraSPARC or IBM Power5+ processor and an IBM mainframe chip. The processor 710 is connected to other system components, including one or more memory devices 712, by the interconnection element 714.

The memory 712 stores programs and data during operation of the computer system 702. Thus, the memory 712 may be a relatively high performance, volatile, random access memory such as a dynamic random access memory (“DRAM”) or static memory (“SRAM”). However, the memory 712 may include any device for storing data, such as a disk drive or other nonvolatile storage device. Various examples may organize the memory 712 into particularized and, in some cases, unique structures to perform the functions disclosed herein. These data structures may be sized and organized to store values for particular data and types of data.

Components of the computer system 702 are coupled by an interconnection element such as the interconnection element 714. The interconnection element 714 may include one or more physical busses, for example, busses between components that are integrated within a same machine, but may include any communication coupling between system elements including specialized or standard computing bus technologies such as IDE, SCSI, PCI and InfiniBand. The interconnection element 714 enables communications, such as data and instructions, to be exchanged between system components of the computer system 702.

The computer system 702 also includes one or more interface devices 716 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 702 to exchange information and to communicate with external entities, such as users and other systems.

The data storage element 718 includes a computer readable and writeable nonvolatile, or non-transitory, data storage medium in which instructions are stored that define a program or other object that is executed by the processor 710. The data storage element 718 also may include information that is recorded, on or in, the medium, and that is processed by the processor 710 during execution of the program. More specifically, the information may be stored in one or more data structures specifically configured to conserve storage space or increase data exchange performance. The instructions may be persistently stored as encoded signals, and the instructions may cause the processor 710 to perform any of the functions described herein. The medium may, for example, be optical disk, magnetic disk or flash memory, among others. In operation, the processor 710 or some other controller causes data to be read from the nonvolatile recording medium into another memory, such as the memory 712, that allows for faster access to the information by the processor 710 than does the storage medium included in the data storage element 718. The memory may be located in the data storage element 718 or in the memory 712, however, the processor 710 manipulates the data within the memory, and then copies the data to the storage medium associated with the data storage element 718 after processing is completed. A variety of components may manage data movement between the storage medium and other memory elements and examples are not limited to particular data management components. Further, examples are not limited to a particular memory system or data storage system.

Although the computer system 702 is shown by way of example as one type of computer system upon which various aspects and functions may be practiced, aspects and functions are not limited to being implemented on the computer system 702 as shown in FIG. 7. Various aspects and functions may be practiced on one or more computers having a different architectures or components than that shown in FIG. 7. For instance, the computer system 702 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 702 may be a computer system including an operating system that manages at least a portion of the hardware elements included in the computer system 702. In some examples, a processor or controller, such as the processor 710, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 710 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, which are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Employee Management Processes

In some embodiments, a process of cloning employee teams 800 of a company is illustrated by FIG. 8. The process may be executed by an employee management system, such as the employee management system 102 described above with reference to FIG. 1. According to this example, the process 800 includes acts of receiving a request to clone a team, creating a cloned team based on an original team, and providing a representation of the cloned team to the user.

In act 802, the employee management system stores data descriptive of a team. The data descriptive of the team can include one or more employees and a set of connections between the employees. For example, the set of connections may be representative of relationships between the employees in an organizational structure of a company. In one example, the organizational structure may be a hierarchical structure. In one example, the set of connections can include hierarchical connection in the hierarchical structure.

The data descriptive of the team can be received from one or more external HR applications, such as the external HR applications 112 and 114 described above. In other examples, the data descriptive of the team may be input by the user via a user interface. The data may be stored in a database associated with the employee management system, such as for example the database 118.

The data may include payroll information such as salary, raises, bonuses, benefits as well as other payroll information. In addition, the data may include time and absence information including total amount of hours, days, and years worked, vacation and sick days accrued and taken. The data may also include performance appraisal information including performance reviews, performance evaluations, probation periods, promotions and the like. Other information received from the external HR applications may include recruiting and work force management information, for example, number of requisitions open, future positions planned, the number of employees in the company, the number of employees recently hired, the company attrition rates, historical hire and attrition information, predicted hiring and attrition rates, as well as other data. The data can also include information pertaining to teams, such as the number of teams, the number of employees in each of the teams. The data may also include information input by the user, such as for example allocation information associated with each employee.

In act 804, the employee management system receives a request to clone a team. The request to clone a team can include a selection by the user via a user interface provided on a computer system. The request may be input by the user via the user interface and transmitted to the employee management system, such as the user interface 106. The employee management system may provide an option for the user to clone a team, for example by providing a button in one or more team screens.

In act 806, the employee management system produces a clone of the team including one or more virtual employees corresponding to the original employees of a company. The virtual employees include a set of virtual connections between the virtual employees, which correspond to the set of connections between the original employees in the original team. The cloned team can be added to a listing of teams associated with the company. In some examples, information associated with the virtual employees in the cloned team includes the information pertaining to the employees of the original team.

In act 808, the employee management system displays a representation of the cloned team including a representation of the virtual employees and the set of virtual connections. The representation of the cloned team can include an organizational structure such as a hierarchical structure having multiple levels and the connections representing reporting relationships between the employees in the hierarchical structure.

In one embodiment, the employee management system can calculate financial information or metrics of the cloned team based on the financial information or metrics of the employees in the original team. The metrics can be calculated based on current and future salary, overhead, raises, bonuses, benefits and other financial information associated with the employees in the cloned team. In other examples, the employee management system stores data associated with an allocation for each virtual employee. The allocation information may be received from the user via the user interface. The allocation may include, in one example, a percentage of workload of each virtual employee in a particular team in relation to other teams.

One or more metrics may be calculated for the virtual employee and the cloned team based on the allocation. The cost of the team, in one example, may be calculated by each person's salary divided by their allocation. The financial information may be displayed as a representation to the user, for example as a chart, or a graph. Other metrics may be calculated such as, performance metrics, profit and loss metrics, and FTE metrics, described above.

In various examples, the employee management system can manage or edit the cloned team and the virtual employees within the cloned team. For example, the virtual employees may be added, removed or moved within the cloned team. The employee management system can receive a request to add, remove, or move a virtual employee from the user via the user interface and add, remove or move the virtual employee within the team.

In response to receiving the request, the employee management system can add, remove or move a virtual employee within the team and provide a representation of the team accordingly. In addition, the employee management system can edit the connections or links associated with the virtual employee accordingly, for example, removing the link if the employee management system received a request to remove the virtual employee, or adding the link if the employee management system received a request to add a virtual employee. To add an employee to the cloned team, the employee management system can provide for the user to select an employee from a list of employees, for example employees stored in the database.

In addition, the employee management system can receive a request to add an open position for an employee on the cloned team. In response to receiving the request, the employee management system can add a virtual open position employee within the team and provide a representation of the team to the user accordingly. The open position may correspond to a future employee currently unknown, and include approximated salary and cost information which may be based on historical data and salary information of similarly positioned employees.

The financial information and metrics calculated for the cloned team can be updated as the virtual employees may be added, removed or moved within the cloned team and as new positions are open for the cloned team. A representation of the updated financial information and metrics for the cloned team may be displayed to the user. The employee management system may receive an input to change the cloned team's status from draft to active. In response, the employee management system can change the virtual employees of the cloned team to existing employees on an active team.

According to another embodiment, processes for creating team of teams are executed by an employee management system and are illustrated by FIG. 9. According to this example, the employee management process 900 includes acts of storing data descriptive of a first team and a second team and financial cost associated with the two teams, receiving an instruction to combine the two teams to create a virtual merged team, and displaying the merged virtual team to the user.

In act 902, the employee management system stores data descriptive of a first team including a first set of employees and a first set of connections between the employees in the first team. In act 904, the employee management system stores data descriptive of a second team including a second set of employees and a second set of connections between the employees of the second team. The data descriptive of the first and the second teams may include any number of employees associated with a company. The first and second set of connections may be representative of relationships between the employees of the first and the second team in an organizational structure of a company, respectively. In one example, the organizational structure can include a hierarchical structure and the first and second set of connections can include hierarchical connection in the hierarchical structure.

The data descriptive of the first and second teams can be received from one or more external HR applications, such as the external HR applications 112 and 114 described above. In other examples, the data descriptive of the first and second teams may be input by the user via a user interface. The data may be stored in a database associated with the employee management system, such as for example the database 118.

In act 906, the employee management system stores data descriptive of a financial information associated with the first team and the second team. The financial information may be received via the HR application as described above and may be calculated based on the information received. The data may include payroll, recruiting, HR information, performance appraisal information, workforce management and the like, as described above with reference to act 802. The data may also include information input by the user, such as for example allocation information as described above.

In one embodiment, the employee management system can calculate financial information or metrics for the first and second teams based on the financial information and the allocation information associated with the employees in the first and second teams, as described above. For example, a financial cost for a first team and a financial cost for the second team can be calculated based on salary information for the first and second teams and the allocation for the employees on the first and second teams.

In act 908, the employee management system receives an instruction to combine or merge the first team and the second team to produce a virtual merged team (e.g. a team of teams). For example, a user may use the virtual merged team to strategize for a merger of one company with another, to determine overlapping, or redundant positions, and to create a single virtual company structure configured as a single organizational structure.

The request to combine the teams can include a selection by a user in a user interface provided on a computer system. The request may be input by the user via the user interface and transmitted to the employee management system. The virtual merged team comprises the first team and the second team and can include the employees of the first team and the employees of the second team, as well as the respective connections between the employees on each team. The members of the first and the second teams are copied to create a virtual first team and a virtual second team part of the virtual merged team. The virtual first team comprises a first set of virtual employees and the virtual second team comprises a second set of virtual employees and further comprises a first and second set of virtual connections. The first set of virtual employees corresponds to the employees in the first team, and the second set of virtual employees corresponds to the employees in the second team.

The employee management system can display the virtual merged team to the user as a representation, including representations of the virtual first team and the virtual second team, each having a respective set of first and second virtual connection. The employee management system can also determine and display financial information associated with the merged team, which can be based on the financial information stored in act 906. For example, the financial information or metrics for the first and second teams based on the financial information and the allocation information associated with the employees in the first and second teams, can be combined to determine combined financial information or metrics for the virtual merged team. For example, a financial cost for the virtual merged team can be calculated based on salary information for the first and second team and the allocation for the employees on the first and second teams.

In act 912, the virtual merged team is displayed as a merged representation including a first organizational structure and a second organizational structure having the representations of the virtual first and second set of connections representing reporting relationships between the first and second set of virtual employees.

In various examples, the employee management system can provide for the user to manage or edit the virtual merged team and the virtual employees within the virtual merged team. For example, the virtual employees may be added, removed or moved between the first virtual team representation and the second virtual team representation. In one example, the employee management system can receive a request to add, remove, or move a virtual employee from the user via the user interface and add, remove or move the virtual employee within the virtual merged team. For example, the employee management system may provide for the user to move a virtual employee by moving the representation of the employee in the merged representation of the virtual merged team. In addition, the employee management system can edit the connections or links associated with the virtual merged team, for example, removing the link if the virtual employee has been removed, or adding the link if the virtual employee has been added.

In other examples, the employee management system determines merged financial information and merged metrics for the virtual merged team. The merged financial information may be based on the financial information and the metric associated with the first and the second teams calculated above in act 906. In one example, the merged financial information for the virtual merged team is not included in total financial information associated with the company, until the merged team is finalized and the status of the merged team is changed to active status.

The financial information and metrics calculated for the merged team can be updated as the virtual employees may be added, removed or moved within the merged team. A representation of the updated financial information and metrics for the merged team may be displayed to the user. The employee management system may receive an input to change the merged team's status from draft to active. In response, the employee management system can change the virtual employees of the merged team to existing employees on an active team.

Having thus described several aspects of at least one example, it is to be appreciated that various alterations, modifications, and improvements will readily occur to those skilled in the art. For instance, examples and embodiments disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A computer system for creating team of teams comprising:
a memory;
a display; and
at least one processor coupled to the memory and the display, the at least one processor configured to:
store data descriptive of a plurality of teams including a first team comprising of a first plurality of employees and a second team comprising of a second plurality of employees;
store data descriptive of a first set of connections between the first plurality of employees and a second set of connections between the second plurality of employees;
store data descriptive of a financial cost for the first team and a financial cost of the second team;
receive an instruction to combine the first team with the second team to produce a virtual team; and
compute a financial cost associated with the virtual team comprising of the financial cost for the first team and the second team.

2. The system of claim 1, wherein the at least one processor is further configured to:
store data descriptive of the virtual team, the virtual team comprising of a plurality of virtual employees based on the first plurality of employees and the second plurality of employees; and
store data descriptive of a set of virtual connections between the plurality of virtual employees based on the first set of connections and the second set of connections.

3. The system of claim 2, wherein the at least one processor is further configured to display a representation of the virtual team including representations the plurality of virtual employees, and the set of virtual connections.

4. The system of claim 1, wherein the at least one processor is further configured to:
receive a request to remove at least one virtual employee from the virtual team;
remove, in response to receiving the request, the at least one virtual employee from the plurality of virtual employees; and
remove, in response to receiving the request, at least one virtual connection of the set of virtual connections, the at least one virtual connection being associated with the at least one virtual employee.

5. The system of claim 1, wherein the at least one processor is further configured to:
receive a request to add at least one new virtual employee to the virtual team;
add, in response to receiving the request, the at least one new virtual employee to the plurality of virtual employees; and
add, in response to receiving the request, a new virtual connection to the set of virtual connections, the new virtual connection being associated with the at least one new virtual employee.

6. The system of claim 1, wherein the at least one processor is further configured to store data descriptive of the at least one new employee including data descriptive of a virtual salary and a virtual position.

7. The system of claim 1, wherein the at least one processor is further configured to:
receive a request to move at least one virtual employee within the virtual team; and
adjust, in response to receiving the request, a connection of the set of virtual connections, the connection being associated with the at least one virtual employee.

8. The system of claim 1, wherein the at least one processor is further configured to store data comprising an allocation for each virtual employee of the plurality of virtual employees.

9. The system of claim 8, wherein the at least one processor is further configured to store the allocation as a percentage of workload of each virtual employee associated with the merged team in relation to other teams.

10. The system of claim 9, wherein the at least one processor is further configured to compute the financial cost based on salary information and the allocation.

11. A method of creating team of teams comprising:
storing data descriptive of a plurality of teams including a first team comprising of a first plurality of employees and a second team comprising of a second plurality of employees;
storing data descriptive of a first set of connections between the first plurality of employees and a second set of connections between the second plurality of employees;
storing data descriptive of a financial cost for the first team and a financial cost of the second team;
receiving an instruction to combine the first team with the second team to produce a virtual team; and
computing a financial cost associated with the virtual team comprising of the financial cost for the first team and the second team.

12. The method of claim 11, further comprising:
storing data descriptive of the virtual team, the virtual team comprising of a plurality of virtual employees based on the first plurality of employees and the second plurality of employees; and
storing data descriptive of a set of virtual connections between the plurality of virtual employees based on the first set of connections and the second set of connections.

13. The method of claim 12, further comprising displaying a representation of the virtual team including representations the plurality of virtual employees, and the set of virtual connections.

14. The method of claim 11, further comprising:
receiving a request to remove at least one virtual employee from the virtual team;
removing, in response to receiving the request, the at least one virtual employee from the plurality of virtual employees; and
removing, in response to receiving the request, at least one connection of the set of virtual connections, the at least one connection being associated with the at least one virtual employee.

15. The method of claim 11, further comprising:
receiving a request to add at least one new virtual employee to the virtual team;
adding, in response to receiving the request, the at least one new virtual employee to the plurality of virtual employees; and
adding, in response to receiving the request, a new virtual connection to the set of virtual connections, the new virtual connection being associated with the at least one new virtual employee.

16. The method of claim 11, further comprising storing data descriptive of the at least one new virtual employee including data descriptive of a virtual salary and a virtual position.

17. The method of claim 11, further comprising:
receiving a request to move at least one virtual employee within the virtual team; and
adjusting, in response to receiving the request, a connection of the set of virtual connections, the connection being associated with the at least one virtual employee.

18. The method of claim 11, further comprising storing data comprising an allocation for each virtual employee of the plurality of virtual employees, wherein the allocation is a percentage of workload of each virtual employee associated with the virtual team in relation to other teams.

19. The method of claim 18, further comprising computing the financial cost based on salary information and the allocation.

20. A non-transitory computer readable medium storing instructions executable by at least one processor of a computer system, the instructions that instruct the computer system to:
store data descriptive of a plurality of teams including a first team comprising of a first plurality of employees and a second team comprising of a second plurality of employees;
store data descriptive of a first set of connections between the first plurality of employees and a second set of connections between the second plurality of employees;
store data descriptive of a financial cost for the first team and a financial cost of the second team;
receive an instruction to combine the first team with the second team to produce a virtual team; and
compute a financial cost associated with the virtual team comprising of the financial cost for the first team and the second team.
